(19) United States
(12) Patent Application Publication
(10) Pub. No.: US 2026/0066175 A1
(43) Pub. Date: Mar. 5, 2026

(54) Wireless Power Receiving Device with a Magnet and a Choke

(71) Applicant: Apple Inc., Cupertino, CA (US)

(72) Inventors: Guanghua Li, San Jose, CA (US); Wegene H. Tadele, San Francisco, CA (US); Viswa B. Pilla, San Jose, CA (US)

(21) Appl. No.: 19/227,879

(22) Filed: Jun. 4, 2025

Related U.S. Application Data
(60) Provisional application No. 63/689,094, filed on Aug. 30, 2024.

(51) Int. Cl. H01F 27/06; H01F 27/02; H01F 27/28; H01F 27/42; H02J 50/00; H02J 50/10

(52) U.S. Cl. CPC H01F 27/06; H01F 27/02; H01F 27/2885; H01F 27/42; H02J 50/005; H02J 50/10; H01F 2027/065

(57) ABSTRACT

A wireless charging system may include a wireless power receiving device that receives wireless power signals from a wireless power transmitting device. The wireless power receiving device may include first and second chokes connected to respective first and second ends of a wireless power transfer coil. The first and second chokes may be disposed relative to the magnet in a manner to reduce relative inductance differences.

This application claims the benefit of U.S. provisional Ser. No. 63/689,094 , filed Aug. 30, 2024, which is hereby incorporated by reference herein in its entirety.

### FIELD

This relates generally to power systems and, more particularly, to wireless power systems for charging electronic devices.

### BACKGROUND

In a wireless charging system, a wireless power transmitting device transmits wireless power to a wireless power receiving device. The wireless power receiving device charges a battery and/or powers components using the wireless power. Each one of the wireless power receiving device and the wireless power transmitting device includes a wireless power transfer coil. Efficient coupling between the wireless power transfer coils in the wireless power transmitting device and the wireless power receiving device can beneficially promote charge performance, reducing charging time.

### SUMMARY

An electronic device may include a magnet generating a magnetic field having poles aligned by a first axis, a wireless power transfer coil having first and second opposing ends, a rectifier connected to the wireless power transfer coil, and a choke connected between the first end of the wireless power transfer coil and the rectifier. The choke may include a coil wound about a second axis that is orthogonal to the first axis.

An electronic device may include a magnet having a center, a wireless power transfer coil having first and second opposing ends, a rectifier connected to the wireless power transfer coil, a first choke that is connected between the first end of the wireless power transfer coil and the rectifier and that is a first distance from the center of the magnet, and a second choke that is connected between the second end of the wireless power transfer coil and the rectifier and that is a second distance from the center of the magnet. The second distance may be within 5% of the first distance.

An electronic device may include a housing, a magnet in the housing that generates a magnetic field having poles aligned by a first axis, and direct current to direct current power converter circuitry in the housing. The direct current to direct current power converter circuitry may include a choke and the choke may include a coil wound about a second axis that is orthogonal to the first axis.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a perspective view of an illustrative choke in accordance with some embodiments.

FIG. 4 is a cross-sectional side view of an illustrative power receiving device with chokes at different distances from a magnet and having axes parallel to an axis of the magnet in accordance with some embodiments.

FIG. 5 is a top view of the illustrative power receiving device of FIG. 4 in accordance with some embodiments.

FIG. 6 is a top view of an illustrative power receiving device with chokes that are equidistant to a magnet in accordance with some embodiments.

FIG. 7 is a cross-sectional side view of an illustrative power receiving device with chokes on the same printed circuit board that vertically overlap in accordance with some embodiments.

FIG. 8 is a cross-sectional side view of an illustrative power receiving device with chokes on different printed circuit boards that vertically overlap in accordance with some embodiments.

FIG. 9 is a cross-sectional side view of an illustrative power receiving device with a shield that is interposed between chokes and a magnet in accordance with some embodiments.

FIG. 10 is a cross-sectional side view of an illustrative power receiving device with chokes at different distances from a magnet and having axes orthogonal to an axis of the magnet in accordance with some embodiments.

FIG. 11 is a cross-sectional side view of an illustrative power receiving device with a magnet and direct current to direct current power conversion circuitry that includes at least one choke having an axis that is orthogonal to an axis of the magnet in accordance with some embodiments.

### DETAILED DESCRIPTION

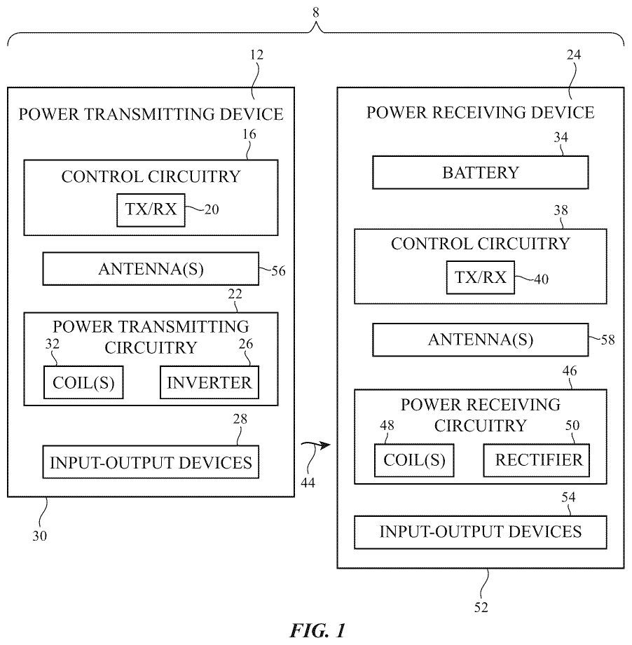

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, 6.78 MHz, 13.56 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage Vrect) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band-communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band-communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Antennas 56 and 58 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

Antennas 56 and 58 may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, antennas 56 and 58 may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas 56 and 58 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

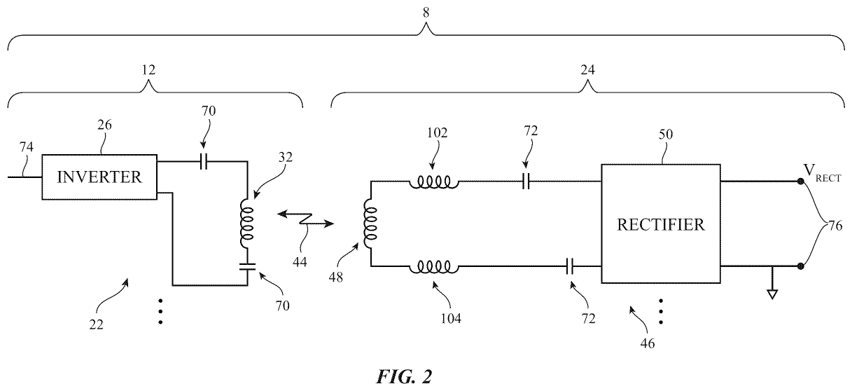

FIG. 2 is a circuit diagram of illustrative wireless charging circuitry for system 8. As shown in FIG. 2, circuitry 22 may include inverter circuitry such as one or more inverters 26 or other drive circuitry that produces wireless power signals that are transmitted through an output circuit that includes one or more coils 32 and one or more capacitors such as capacitors 70. The resonant capacitor(s) 70 may be in series with coil 32 or in parallel with coil 32. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at control input 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26.

During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24. Resonant capacitor(s) 72 may be in series with coil 48 or in parallel with coil 48.

Rectifier circuitry 50 is coupled to one or more coils 48 and converts received power from AC to DC and supplies a corresponding direct current output voltage Vrect across rectifier output terminals 76 for powering load circuitry in device 24 (e.g., for charging battery 34, for powering a display and/or other input-output devices 54, and/or for powering other components).

Wireless power receiving circuitry 46 may include one or more chokes such as chokes 102 and 104. Chokes are inductors that attenuate (block) higher-frequency alternating current (AC) while allowing lower-frequency AC or direct current (DC) to pass through. Choke 102 is connected between a first side of coil 48 and rectifier 50. Choke 104 is connected between a second side of coil 48 and rectifier 50.

Chokes 102 and 104 may attenuate the flow of wireless signals at or near a target frequency. The target frequency may be selected to attenuate frequencies of interest for a particular application. As an example, chokes 102 and 104 herein may attenuate the flow wireless signals at or near 600 MHz. The chokes may attenuate a range of frequencies that includes the target frequency. For example, frequencies between 600 MHz and 1000 MHz may be effectively attenuated by chokes 102 and 104. In general, any target frequency may be used. The target frequency may be chosen to improve coexistence with radio frequency signals at wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands, and/or any of the other communications bands discussed in connection with antennas 56 and 58 above. Attenuating these relatively higher frequency AC signals (as compared with wireless charging signals) may mitigate antenna losses in wireless power receiving circuitry 46. Chokes 102 and 104 ensure that signals from antenna(s) 58 are radiated outward instead of being absorbed and terminated before transmission.

To maintain functionality of wireless power receiving circuitry 46, chokes 102 and 104 pass signals at frequencies at or near the wireless charging operating frequency in the kHz and/or low MHz range. The chokes may be sized to pass signals at one or more expected power transmission frequencies and attenuate signals at out-of-band-communication frequencies used by antenna(s) 58.

Chokes 102 and 104 may have a maximum impedance at the target frequency (selected to attenuate frequencies of interest) and may have a minimum impedance at or near the wireless charging operating frequency. A ratio between the maximum impedance and the minimum impedance of the chokes may be greater than 5:1, greater than 10:1, greater than 20:1, greater than 50:1, etc. A ratio between an impedance of the chokes at a cellular frequency and an impedance of the chokes at the wireless charging operating frequency may be greater than 5:1, greater than 10:1, greater than 20:1, greater than 50:1, etc.

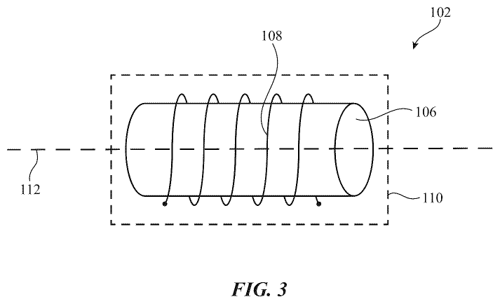

FIG. 3 is a perspective view of an illustrative choke. FIG. 3 shows choke 102, but it is noted that choke 104 (and any of the other chokes described herein) may have the same arrangement as choke 102. As shown in FIG. 3, choke 102 (sometimes referred to as a choke coil, choke inductor, etc.) includes a core 106 and a winding 108. In some arrangements, core 106 may be omitted and air may be used as the core for choke 102. Winding 108 is a coil of wire that is wound about the core. Winding 108 is wound about a longitudinal axis 112 (e.g., axis 112 intersects the center of each loop of winding 108). Choke 102 may also optionally include an enclosure 110 that shields the core and winding from environmental factors and physical damage.

Core 106 (sometimes referred to as magnetic core 106) may be formed from a soft magnetic material such as ferrite. Magnetic cores (such as magnetic core 106) may have a high magnetic permeability, allowing them to guide the magnetic fields in the system. The example of using ferrite cores is merely illustrative. Other ferromagnetic and/or ferrimagnetic materials such as iron, mild steel, mu-metal (a nickel-iron alloy), a nanocrystalline magnetic material, rare earth metals, or other magnetic materials having a sufficiently high magnetic permeability to guide magnetic fields in the system may be used for one or more cores herein if desired. The magnetic cores may sometimes be referred to as ferrimagnetic cores. Each one of the magnetic cores herein may be a single piece or made from separate pieces. The cores may be molded, sintered, formed from laminations, formed from particles (e.g., ceramic particles) distributed in a polymer, or manufactured by other processes.

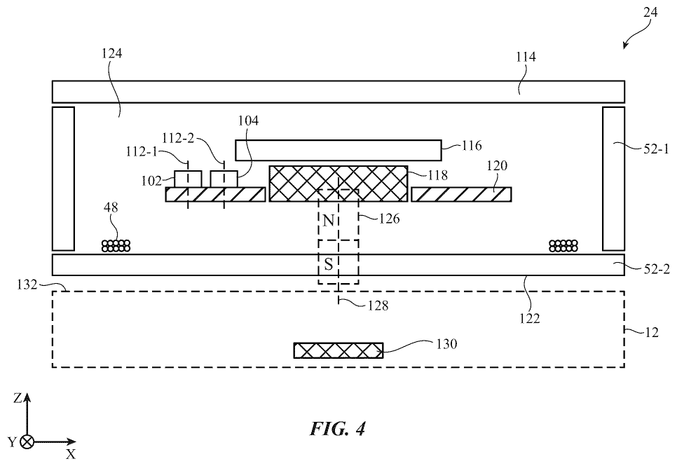

FIG. 4 is a cross-sectional side view of the PRX device 24 of FIGS. 1 and 2. As shown in FIG. 4, PRX device 24 may include one or more components that define an interior enclosure. Housing structure 52-1, housing structure 52-2, and display 114 may defined an interior enclosure 124 (sometimes referred to as simply interior 124) for power receiving device 24. Internal components for power receiving device 24 are positioned within the interior enclosure.

Display 114 may be an organic light-emitting diode (OLED) display, a liquid crystal display (LCD), or any other desired type of display. Display 114 may emit light in the positive Z-direction. Display 114 may be coupled to one or more housing structures such as housing structures 52-1 and 52-2. Housing structure 52-1 may be a conductive housing structure formed from metal whereas housing structure 52-2 may be a non-conductive housing structure formed from glass, polymer, sapphire, or another desired material. Housing structure 52-2 may define an exterior housing surface 122. Surface 122 may optionally have convex curvature (not shown). The example in FIG. 4 of PRX device 24 including one conductive housing structure and one non-conductive housing structure is merely illustrative. Housing 52 may include any desired number of housing structures with any desired shapes and formed from any desired materials.

The components within interior 124 of power receiving device 24 include coil 48, magnet 118, printed circuit board 120, shield 116, choke 102, and choke 104.

Magnet 118 may be a permanent magnet (e.g., an object made from a material that is magnetized and creates its own persistent magnetic field) or an electromagnet (e.g., where magnetic field is produced by an electric current). The electromagnet may be a DC electromagnet. When magnet 118 is an electromagnet, the electromagnet may include wire wound about a magnetic core. Magnet 118 may have associated magnetic poles 126 that are aligned by a corresponding axis 128 (sometimes referred to as magnetic axis 128, dipole axis 128, etc.).

Shield 116 may be a shield that blocks and/or redirects the magnetic field of magnet 118. Shield 116 may prevent components such as display 114 from being exposed to the magnetic field generated by magnet 118. Shield 116 may be a ferromagnetic shield that comprises iron, nickel, or cobalt, as one example.

During power transfer operations, PRX device 24 may mate with a corresponding PTX device 12. As shown in FIG. 4, PTX device 12 may have a housing surface 132 that mates with (conforms to) housing surface 122 of PRX 24. If housing surface 122 has curvature, housing surface 132 may have conformal curvature. In the example where housing surface 122 has convex curvature, housing surface 132 may have concave curvature that mates with the convex curvature. PTX device 12 may also include a magnet 130 that is configured to magnetically couple to magnet 118 in PRX device 24. When magnets 118 and 130 are magnetically coupled, a coil in PTX device 12 may be aligned with coil 48 in PRX device 24.

As shown in FIG. 4, shield 116 is positioned between magnet 118 and display 114. This position for shield 116 mitigates the exposure of some components (such as display 114) within PRX device 24 to the magnetic field of magnet 118 while allowing magnet 118 to magnetically couple with magnet 130 in PTX device 12 during wireless charging operations.

FIG. 4 further shows printed circuit board 120 with chokes 102 and 104 mounted on the printed circuit board 120. Magnet 118 may be formed in a central opening in printed circuit board 120 (as shown in the example of FIG. 4). Alternatively, magnet 118 may be mounted on an upper surface of printed circuit board 120.

As previously discussed in connection with FIG. 3, each choke has a wire that is wound about a respective axis 112. FIG. 4 shows an example where choke 102 has a corresponding axis 112-1 and choke 104 has a corresponding axis 112-2. In FIG. 4, axes 112-1 and 112-2 are parallel to magnetic axis 128 of magnet 118. When chokes 102 and 104 have this orientation, the magnetic field generated by magnet 118 may change the effective inductance of chokes 102 and 104.

Consider an example where, in the absence of any magnetic field, the inductance of chokes 102 and 104 is 145 nH. The magnetic field from magnet 118 having a magnetic axis 128 parallel to axes 112-1 and 112-2 causes the effective inductance of chokes 102 and 104 to drop. The drop in effective inductance of the chokes may be proportional to the strength of the magnetic field exposed to the chokes. In FIG. 4, choke 104 is closer to magnet 118 than choke 102 and therefore may be exposed to a stronger magnetic field than choke 102. In the presence of the magnetic field generated by magnet 118, the effective inductance of choke 104 therefore drops by a greater amount than the effective inductance of choke 102. As one specific example, the magnetic field may cause the effective inductance of choke 104 to drop to 30 nH whereas the magnetic field may cause the effective inductance of choke 102 to drop to 100 nH.

Varying change in inductance in chokes 102 and 104 caused by the magnetic field is undesirable. The varying change in inductance in chokes 102 and 104 caused by the magnetic field may cause an imbalance in impedance at differential input leads to rectifier 50, which may increase common-mode noise, which may cause undesired increases to radiated and conducted emissions. The drop in inductance in chokes 102 and 104 caused by the magnetic field may also undesirably compromise the efficacy of the chokes in attenuating target frequencies.

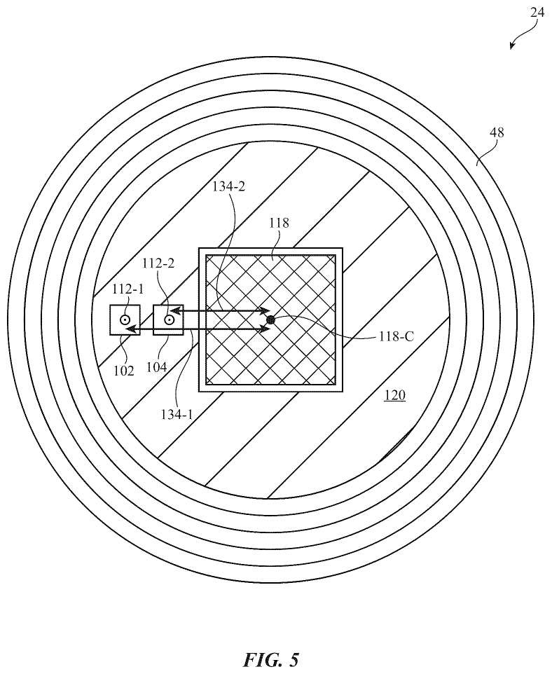

FIG. 5 is a top view showing the illustrative PRX device 24 of FIG. 4. Coil 48 has an inner diameter that defines a central opening and printed circuit board 120, magnet 118, choke 102, and choke 104 are all positioned within the central opening. As shown, magnet 118 has a center 118-C (that is aligned with magnetic axis 128 from FIG. 4). Choke 102 has a center that is aligned with axis 112-1 and that is separated from center 118-C by a distance 134-1. Choke 104 has a center that is aligned with axis 112-2 and that is separated from center 118-C by a distance 134-2. In FIGS. 4 and 5, distance 134-1 is greater than distance 134-2, causing a varying change in inductance in chokes 102 and 104 caused by the magnetic field as previously discussed.

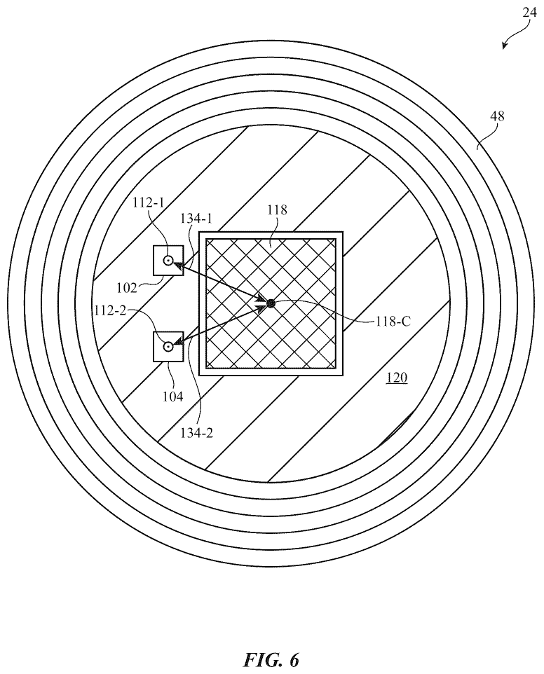

To mitigate differences in the inductance drop in chokes 102 and 104 caused by the magnetic field, the chokes 102 and 104 may be positioned approximately the same distance from center 118-C. FIG. 6 is a top view of an illustrative PRX device 24 with chokes 102 and 104 positioned equidistance from center 118-C of magnet 118. In the example of FIG. 6, distances 134-1 and 134-2 are equal. It is noted, however, that the distances need not be exactly equal. The closer distances 134-1 and 134-2 are to being equal, the more similar the inductance drop in chokes 102 and 104. System constraints on the positioning of chokes 102 and 104 may cause distances 134-1 and 134-2 to not be exactly equal. Distance 134-2 may be within 20% of distance 134-1, within 10% of distance 134-1, within 5% of distance 134-1, within 3% of distance 134-1, within 1% of distance 134-1, etc. Distance 134-1 may be within 20% of distance 134-2, within 10% of distance 134-2, within 5% of distance 134-2, within 3% of distance 134-2, within 1% of distance 134-2, etc.

The distance between chokes 102/104 and magnet 118 may be characterized by a center-to-center distance (as in FIGS. 5 and 6), an edge-to-edge distance, a center-to-edge distance, or an edge-to-center distance. Using the same characterization of distance between chokes 102/104 and magnet 118, the distance between chokes 102/104 and magnet 118 may be equal or close to equal (e.g., within 20%, within 10%, within 5%, within 3%, within 1%, etc.).

FIG. 6 depicts chokes 102 and 104 on the same side of magnet 118. This example is merely illustrative. Chokes 102 and 104 may be positioned at any desired locations relative to magnet 118 (e.g., on opposing sides of magnet 118) while remaining approximately equidistant to magnet 118.

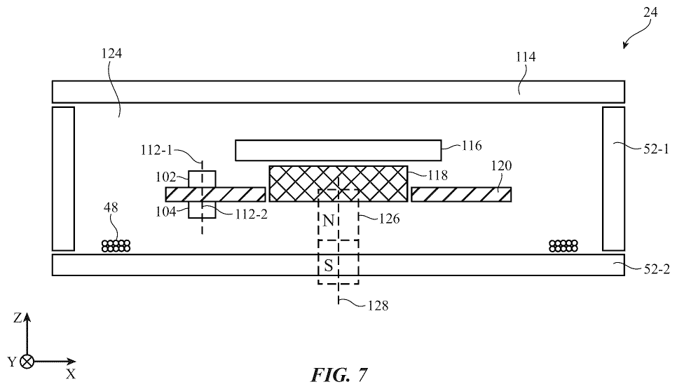

To mitigate the difference between the distances between chokes 102/104 and magnet 118, the chokes may be vertically stacked. FIG. 7 is a cross-sectional side view of an illustrative PRX device 24 with chokes that vertically overlap. As shown, magnetic axis 128 extends in the Z-direction, choke 102 has an axis 112-1 that extends in the Z-direction, choke 104 has an axis 112-2 that extends in the Z-direction, and chokes 102 and 104 overlap in the Z-direction. Because chokes 102 and 104 overlap in the Z-direction, the distance between choke 102 and magnet 118 is equal or close to equal to (e.g., within 20%, within 10%, within 5%, within 3%, within 1%, etc.) the distance between choke 104 and magnet 118.

In FIG. 7, the vertically overlapping chokes are both mounted to the same printed circuit board 120. Choke 102 is mounted to an upper surface of printed circuit board 120 whereas choke 104 is mounted to a lower surface of printed circuit board 120. This example is merely illustrative.

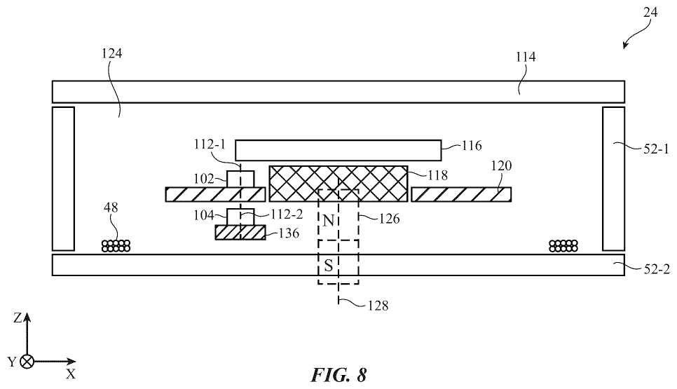

In another possible arrangement, shown in FIG. 8, chokes 102 and 104 may be mounted to different printed circuit boards. In FIG. 8, choke 102 is mounted to an upper surface of printed circuit board 120 whereas choke 104 is mounted to an upper surface of printed circuit board 136. In FIG. 8, magnetic axis 128 extends in the Z-direction, choke 102 has an axis 112-1 that extends in the Z-direction, choke 104 has an axis 112-2 that extends in the Z-direction, and chokes 102 and 104 overlap in the Z-direction.

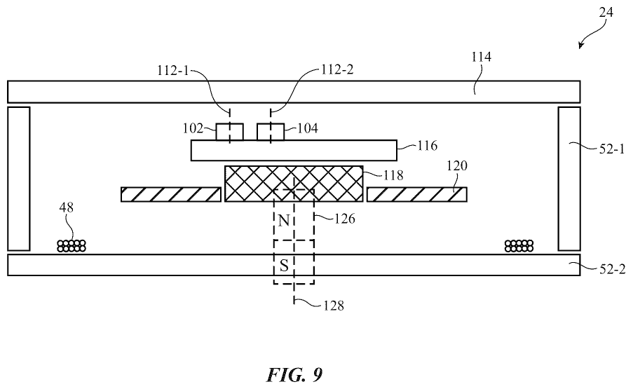

To mitigate the inductance drop in chokes 102 and 104 caused by the magnetic field, chokes 102 and 104 may be positioned on the opposite side of shield 116 as magnet 118. FIG. 9 is a cross-sectional side view of an illustrative PRX device 24 with a shield 116 interposed between magnet 118 and chokes 102 and 104. As shown, shield 116 is interposed between magnet 118 and choke 102 and therefore shields choke 102 from the magnetic field created by magnet 118. Choke 102 therefore experiences little to no drop in inductance from the magnetic field from magnet 118. Shield 116 is interposed between magnet 118 and choke 104 and therefore shields choke 104 from the magnetic field created by magnet 118. Choke 104 therefore experiences little to no drop in inductance from the magnetic field from magnet 118.

Another option to mitigate the inductance drop in chokes 102 and 104 caused by the magnetic field is to orient chokes 102 and 104 with their axes orthogonal to the axis of magnet 118. A choke may be susceptible to a substantial inductance drop when exposed to a magnetic field when the choke has an axis that is parallel to the axis of the magnet producing the magnetic field. In FIGS. 4-9, chokes 102 and 104 have axes that are parallel to the axis of magnet 118 and are therefore susceptible to saturation and corresponding inductance drop caused by the magnetic field from magnet 118.

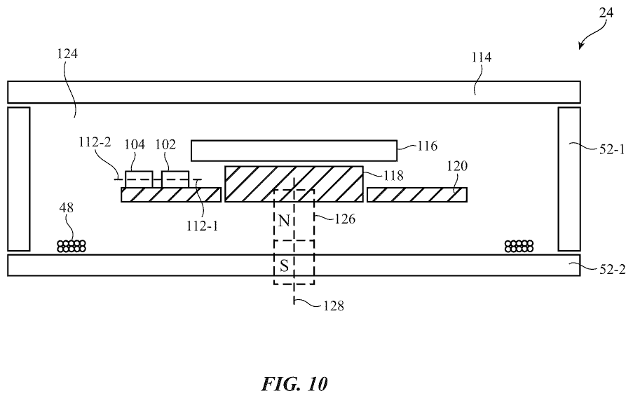

However, a choke may not be susceptible to a substantial inductance drop when exposed to a magnetic field when the choke has an axis that is orthogonal to the axis of the magnet producing the magnetic field. FIG. 10 is a cross-sectional side view of an illustrative PRX device 24 with chokes 102 and 104 that have axes that are orthogonal to the axis of magnet 118. Choke 102 is mounted on the upper surface of printed circuit board 120. Choke 102 has an associated axis 112-1 that is orthogonal to axis 128 of magnet 118. Choke 102 therefore does not experience an inductance drop even when exposed to the magnetic field of magnet 118. Choke 104 is mounted on the upper surface of printed circuit board 120. Choke 104 has an associated axis 112-2 that is orthogonal to axis 128 of magnet 118. Choke 104 therefore does not experience an inductance drop even when exposed to the magnetic field of magnet 118.

In FIG. 10, choke 102 is closer to magnet 118 than choke 104. However, unlike in FIGS. 4 and 5 (where the chokes have axes parallel to the magnetic axis and therefore experience varying inductance drops caused by the magnetic field), the chokes in FIG. 10 do not experience substantial inductance drop from the magnetic field. The adverse effects of the chokes being different distances from magnet 118 in FIGS. 4 and 5 are therefore obviated in FIG. 10 due to the orientation of chokes 102 and 104.

Any choke in PRX device 24 may be oriented such that the axis for that choke is orthogonal to the axis of a magnet producing a magnetic field to which that choke is exposed. Orienting the chokes in this manner may mitigate inductance drops otherwise caused by exposure of the chokes to the magnetic field (when the chokes have parallel axes to the magnetic axis).

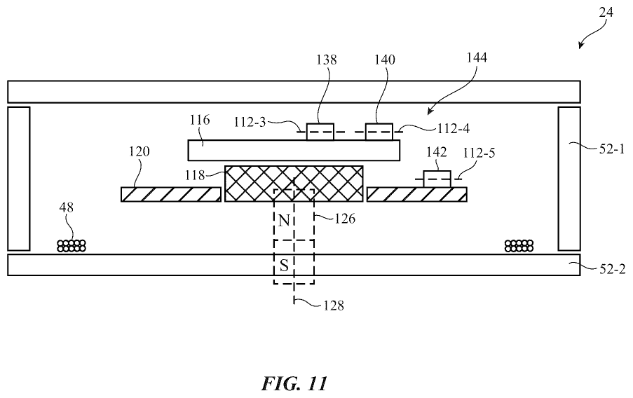

FIG. 11 is a cross-sectional side view of an illustrative PRX device 24 with additional chokes. FIG. 11 shows choke 138 having a respective axis 112-3, choke 140 having a respective axis 112-4, and choke 142 having a respective axis 112-5. Each one of axes 112-3, 112-4, and 112-5 is orthogonal to axis 128 to prevent inductance drop in the chokes when exposed to the magnetic field of magnet 118.

In the example of FIG. 11, chokes 138, 140, and 142 may be part of direct current to direct current power converter circuitry 144. Direct current to direct current power converter circuitry 144 may include a boost converter and/or a buck converter. The direct current power converter circuitry 144 may include one or more chokes such as chokes 138, 140, and 142. Chokes 138, 140, and 142 may each be part of either a boost converter or a buck converter.

The example of chokes 138, 140, and 142 being part of direct current to direct current power converter circuitry 144 is merely illustrative. In general, each one of chokes 138, 140, and 142 may be used for any desired application within PRX device 24.

If desired, chokes 102 and 104 may be implemented with air cores to mitigate inductance drop caused by exposure to the magnetic field of magnet 118.

In another possible arrangement, chokes 102 and 104 may be implemented as a common mode choke where both chokes share a common core. When chokes 102 and 104 share a common core, the chokes will necessarily be positioned the same distance from magnet 118 which may mitigate differences in the inductance drops of the cores when exposed to the magnetic field from magnet 118.

Although shown here in connection with PRX device 24, it should be understood that any of the arrangements herein may also be applied to a one or more chokes within PTX device 12.

The foregoing is merely illustrative and various modifications can be made to the described embodiments. The foregoing embodiments may be implemented individually or in any combination.

What is claimed is:

1. An electronic device comprising:
a magnet generating a magnetic field having poles aligned by a first axis;
a wireless power transfer coil having first and second opposing ends;
a rectifier connected to the wireless power transfer coil; and
a choke connected between the first end of the wireless power transfer coil and the rectifier, wherein the choke comprises a coil wound about a second axis that is orthogonal to the first axis.

2. The electronic device of claim 1, wherein the choke is a first choke, the coil is a first coil, and the electronic device further comprises:
a second choke connected between the second end of the wireless power transfer coil and the rectifier, wherein the second choke comprises a second coil wound about a third axis that is orthogonal to the first axis.

3. The electronic device of claim 2, further comprising:
a circuit board having first and second opposing surfaces, wherein the first choke is mounted on the first surface of the circuit board and wherein the second choke is mounted on the second surface of the circuit board.

4. The electronic device of claim 3, wherein the first and second chokes are overlapping in a direction that is parallel to the first axis.

5. The electronic device of claim 2, wherein the first choke is a first distance from a center of the magnet, wherein the second choke is a second distance from the center of the magnet, and wherein the second distance is within 5% of the first distance.

6. The electronic device of claim 1, wherein the choke is configured to attenuate signals at frequencies between 600 MHz and 1000 MHz.

7. The electronic device of claim 1, wherein the choke is configured to attenuate signals at cellular frequencies.

8. The electronic device of claim 1, wherein the wireless power transfer coil is configured to receive wireless power signals at a wireless power transfer frequency and wherein the choke is configured to pass signals at the wireless power transfer frequency.

9. The electronic device of claim 1, wherein the choke has a first impedance at a cellular frequency and a second impedance at a wireless power transfer frequency and wherein a ratio of the first impedance to the second impedance is greater than 5:1.

10. The electronic device of claim 1, further comprising:
one or more additional electronic components; and
a shield that shields the one or more additional electronic components from the magnetic field.

11. The electronic device of claim 10, further comprising:
a housing having a housing surface, wherein the magnet is interposed between the shield and the housing surface and wherein the choke is interposed between the shield and the housing surface.

12. The electronic device of claim 1, wherein the wireless power transfer coil has a central opening within the inner diameter of the wireless power transfer coil and wherein the magnet and the choke are positioned in the central opening.

13. An electronic device comprising:
a magnet having a center;
a wireless power transfer coil having first and second opposing ends;
a rectifier connected to the wireless power transfer coil;
a first choke connected between the first end of the wireless power transfer coil and the rectifier, wherein the first choke is a first distance from the center of the magnet; and
a second choke connected between the second end of the wireless power transfer coil and the rectifier, wherein the second choke is a second distance from the center of the magnet, and wherein the second distance is within 5% of the first distance.

14. The electronic device of claim 13, further comprising:
a circuit board having first and second opposing surfaces, wherein the first and second chokes are both mounted on the first surface of the circuit board.

15. The electronic device of claim 13, further comprising:
a circuit board having first and second opposing surfaces, wherein the first choke is mounted on the first surface of the circuit board and wherein the second choke is mounted on the second surface of the circuit board.

16. The electronic device of claim 15, wherein the magnet generates a magnetic field having poles aligned by a first axis and wherein the first and second chokes are overlapping in a direction that is parallel to the first axis.

17. The electronic device of claim 13, further comprising:
a first circuit board, wherein the first choke is mounted on the first circuit board; and
a second circuit board, wherein the second choke is mounted on the second circuit board, wherein the magnet generates a magnetic field having poles aligned by a first axis and wherein the first and second chokes are overlapping in a direction that is parallel to the first axis.

18. The electronic device of claim 13, wherein the first and second chokes are configured to attenuate signals at frequencies between 600 MHz and 1000 MHz.

19. An electronic device comprising:
a housing;
a magnet in the housing that generates a magnetic field having poles aligned by a first axis; and
direct current to direct current power converter circuitry in the housing, wherein the direct current to direct current power converter circuitry comprises a choke and wherein the choke comprises a coil wound about a second axis that is orthogonal to the first axis.

20. The electronic device of claim 19, wherein the choke comprises a ferrite core and wherein the coil is wound about the ferrite core and wherein the choke is configured to attenuate signals at frequencies between 600 and 1000 MHz.
